(19) United States
(12) Patent Application Publication
(10) Pub. No.: US 2026/0220122 A1
(43) Pub. Date: Jul. 30, 2026

(54) SYSTEMS AND METHODS FOR HETEROGENEOUS DATA ANALYSIS

(71) Applicant: GENENTECH, INC., South San Francisco, CA (US)

(72) Inventors: Louis Matthew MCCONNELL, Santa Cruz, CA (US); Claudia Iriondo, Berkeley, CA (US)

(21) Appl. No.: 19/145,482

(22) PCT Filed: Feb. 2, 2024
(86) PCT No.: PCT/US2024/014145

§ 371 Date: Jul. 2, 2025

Related U.S. Application Data
(60) Provisional application No. 63/444,707, filed on Feb. 10, 2023.
(60) Provisional application No. 63/523,684, filed on Jun. 28, 2023.

(51) Int. Cl. G06F 16/23; G06F 16/25

(52) U.S. Cl. CPC G06F 16/2365; G06F 16/258

(57) ABSTRACT

Disclosed are various approaches for analyzing complex datasets and identifying potential issues with the datasets. A validation schema defining the type of data analysis to be performed on a given dataset can be provided to a data analysis engine. One or more validators associated with different types of data analysis can be selected based at least in part on the validation schema. In various examples, each validator includes one or more executable validator modules that are configured to analyze the data included the dataset based at least in part on the data modality and/or type of data (e.g., time series, continuous, categorical, multidimensional, etc.). A validator results report can be generated according to the output of the validator modules. In some examples, an aggregation of the validator results can be determined and included in the validator results report.

This application claims the benefit of and priority to U.S. Patent Application No. 63/444,707 filed on 10 Feb. 2023, entitled “SYSTEMS AND METHODS FOR HETEROGENEOUS DATA ANALYSIS,” and U.S. Patent Application No. 63/523,684 filed on 28 Jun. 2023, entitled “SYSTEMS AND METHODS FOR HETEROGENEOUS DATA ANALYSIS,” the contents of which are incorporated by reference in their entirety herein.

### BACKGROUND

In an ideal machine learning setting where data is homogeneous and unimodal, users face a variety of challenges in the data preprocessing stages that can quietly compromise the performance of a trained model. Issues around data redundancy, distribution shift, and anomalous data points will not prevent a model from training, but will ultimately hinder performance at test time. Discovering these “silent issues” requires a tremendous amount of manual effort and insight, and even then, the broad scope of data-related issues can make discovery of these issues infeasible. In practical settings, the situation is even more challenging as data often comes from a variety of sources, contains noise and outliers, and exhibits significant shifts due to exogenous noise. In these cases, manual discovery of data-related issues becomes completely infeasible.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting a data analysis framework according to various embodiments of the present disclosure.

FIG. 2 is a drawing of a network environment according to various embodiments of the present disclosure.

FIG. 3 is a drawing depicting how it is possible to leverage the wealth of multidimensional data validation methods with a single representation function per data modality according to various embodiments of the present disclosure.

FIGS. 4-6 are flowcharts illustrating examples of functionality implemented as portions of an application executed in a computing environment in the network environment of FIG. 2 according to various embodiments of the present disclosure.

### DETAILED DESCRIPTION

Disclosed are various approaches for analyzing complex datasets and identifying potential issues with the datasets. According to various embodiments, a validation schema defining the type of data analysis to be performed on a given dataset can be provided to a data analysis system. One or more validators associated with different types of data analysis can be selected based at least in part on the validation schema. In various examples, each validator includes one or more executable validator modules that are configured to analyze the data included the dataset based at least in part on the data modality and/or type of data (e.g., time series, continuous, categorical, multidimensional, etc.). A validator results report can be generated according to the output of the validator modules. In some examples, an aggregation of the validator results can be determined and included in the validator results report.

As data scales both horizontally and vertically, manual data cleaning and inspection strategies that were once merely inefficient prove to be infeasible. This is doubly true for tasks that require examining multiple data columns at once, such as confounding variable analysis and multimodal anomaly detection. Further, there are a number of settings that rely on live-streaming prediction or AutoML based setups based on a patchwork quilt of data domains and modalities. In these setups, the timeline for “data validation” is even shorter, and the data is even messier. These problems present significant challenges to the machine learning community. Machine learning models trained on faulty data or used on out-of-distribution data can result in undetected failure, leading to faulty predictions accepted by end-users. Investigating the issue can be time-consuming, taking months to uncover the root cause.

Known validation tools for identifying specific data related issues are highly effective at finding a single type of issue but are not easily extensible. Some of these validation tools can (1) identify anomalies and outliers within multimodal datasets, time series data, and image data, (2) identify dataset shifts that at inference time that could compromise performance, and (3) check for “linting errors” such as improperly preprocessed data and miscoding errors. In addition, purpose-built validation systems work well but are not modular or versatile to new use cases. One known system performs online validation of home energy systems to detect fraudulent results. Another known system includes unsupervised system for inferring validation rules on online sensor data and verifying them in real time.

Some known validation tools develop frameworks to support arbitrary checks within the context of a specific pipeline or toolset but not designed for highly heterogeneous data. One example validation tool includes a rule-based validation framework for pandas data frames. Another example validation tool introduces TensorFlow Data Validation as a component in a larger machine learning pipeline (TFX) to perform data validation from within the TFX framework. Another example validation tool tests explicit, declarative assumptions on data. Another example validation tool uses an R package for running statistical tests on data.

Although all of the aforementioned tools require explicit declaration of the validations, there are tools that try to infer what should be validated based on the data itself. One example validation tool infers data validation patterns from data lakes and performs validation using these patterns. Another validation tool uses a genetic algorithm to identify validation rules.

There is also an area of research concerning big-picture issues, trends, and best practices around data validation. One practice, for example, includes a 5-role “line of defense” for mitigating risk in machine learning models that includes human-in-the-loop validators that review and approve work from data scientists and data owners. Other issues in data validation includes the importance of human oversight in data validation as well as shortcomings and opportunities for data validation in big data regimes.

To overcome the shortcomings of the known data validation techniques, the present disclosure relates to a modular, extensible data validation framework that seeks to identify data-related issues in real world data. The design principles of the data analysis system of the present disclosure are selected to ensure that the data analysis system is an effective and extensible tool for discovering the problems that one might encounter in real-world datasets that are potentially noisy, heterogeneous, sparse, multimodal, miscoded, and preprocessed incorrectly.

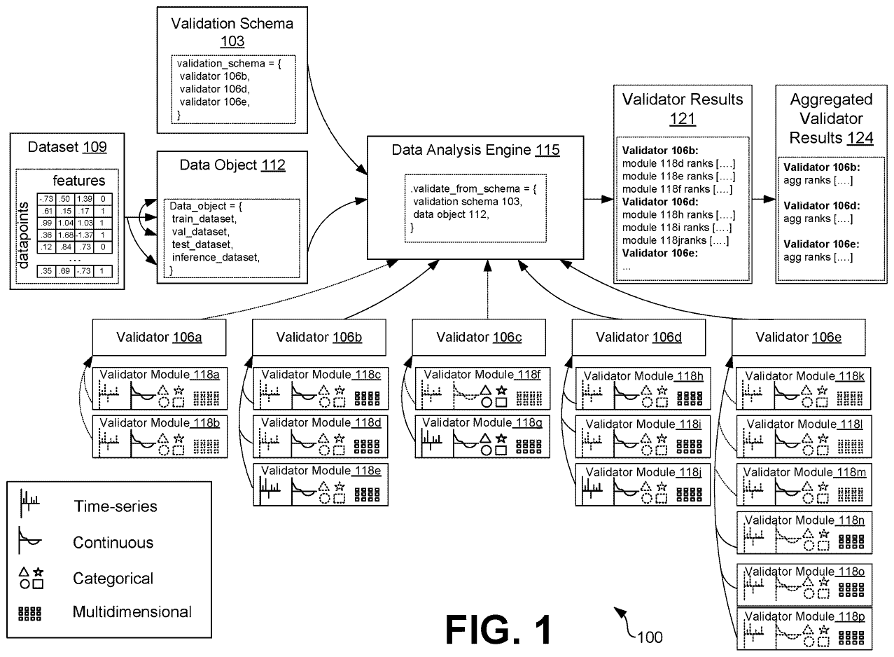

Turning now to FIG. 1 shown is an example framework of a data analysis system 100 of the present disclosure, according to various examples. As shown in FIG. 1, a validation schema 103 identifying the desired validators 106 (e.g., 106a, 106b, 106c, 106d, 106e) for analyzing a dataset 109 and a data object 112 defining the dataset 102 and splits of the dataset (e.g., training dataset, validation dataset, testing dataset, inference dataset, etc.) can be provided to a data analysis engine 115. In various examples, each validator 106 includes one or more executable validator modules 118 (e.g., 118a, 118b, 118c, 118d, 118e, 118f, 118g, 118h, 118i, 118j, 118k, 118l, 118m, 118n, 118o, 118p) that are configured to analyze the data included the dataset 109 based at least in part on the data modality and/or type of data (e.g., time series, continuous, categorical, multidimensional, etc.) being analyzed. In various examples, each executed validator module 118 can return validator results 121 associated with the corresponding analysis.

According to various examples, the data analysis engine 115 automatically identifies the appropriate validators 106 defined by the validation schema 103 and determines the relevant validator modules 118 to be run on the dataset 109 based at least in part on the data types included in the dataset 109 which can be defined by the data object 112. In various examples, a validator results report can be generated according to the validator results 121 that are output from each of the validator modules 118. In some examples, the validator results 121 corresponds to a ranking of scores associated with the detected issues. In other examples, the validator results 121 can comprise probabilities associated with data issues. In some examples, aggregated validator results 124 corresponding to an aggregation of the validator results 121 associated with each validator 106 can be calculated and included in the validator results report provided to the user.

In the example of FIG. 1, the dashed lines represent unused validator modules 118 and validators 106. For example, validator modules 118 may be excluded because there are no columns of the relevant data type included in the dataset 109 or because they are manually excluded from the validation schema 103. In various examples, validators 106 can be excluded by the data analysis engine 115 when they are excluded from the validation schema 103. In the example of FIG. 1, the dataset 109 includes only multidimensional data. As such, only the multidimensional validator modules 118 (e.g., 118c, 118d, 118e, 118g, 118h, 118i, 118j, 118n, 118o, 118p) for the selected validators 106 (e.g., 106b, 106d, 106e) are selected by the data analysis engine 115 to analyze the data included in the dataset 109.

According to various examples, the dataset 109 can comprise a torch dataset describing the data type of each of its columns with a data object 112 mapping each column to its data type. In order to make use of some of validators 106 of the data analysis system 100, the dataset 109 may need to be preprocessed and split, as this allows the data analysis engine 115 to find mistakes from the preprocessing stage (e.g., miscoding errors) or the splitting stage (e.g., splits that are not independent and identically distributed (IID)). In some examples, a raw unsplit dataset 109 can be provided if the user does not want to include these checks. In some examples, if the user wants to override the default run configuration, the user can provide a validation schema 103 specifying included validations and their options. From there, the data analysis engine 115 automatically identifies the relevant validator modules 118 from the selected validators 106 for each data type and applies them, returning the validator results 121 back to the user.

According to various examples, data modality abstraction present in the validator/validator module architecture of a data analysis system 100 makes it possible to support very heterogeneous data with minimal specification. Because validators 106 automatically identify the relevant validator modules 118 for a given data type, additional validator modules 118 can be written and included with a given validator 106 to support a custom data type and extend a fixed type of validation to a new data type. This is especially effective for situations where the input dataset 109 includes a large number of modalities, as the data analysis system 100 is automatically able to apply relevant validator modules 118 to the new data modality.

When trying to run a large number of validations on a large number of custom data modalities, the number of added validator modules 118 that need to be written may be infeasible. For example, consider trying to run an anomaly detection validation, an OOD at inference validation, and a conditional independence test on three new data modalities that do not yet have support in the data analysis framework. The naive approach would require the user to write nine new methods: one for each combination of data modality and validation. For that reason, it may be easier to maintain a set of representation functions (e.g., word2vec or ResNet encoders) that map each data modality to a multidimensional continuous vector that contains a compressed representation of the data modality and then use a set of existing multidimensional validator methods to perform all of the data analysis system's checks. In the above example, this would mean that the user would only need to include three representation functions to perform all nine validation combinations. Alternatively, users can also create validator modules 118 to map from high dimensional feature spaces, such as images and audio data, to a low-dimensional descriptive representations such as a histogram or bandlimited spectrograph. This approach allows users to benefit from the set of existing multidimensional continuous validator modules 118 implemented in the data analysis system 110 without necessarily training a model to learn a representation for the new data type.

Although this may be the faster approach to include a new data type in the full suite of validations, there are some cases where specific validator modules 118 for data types may be necessary to map directly from the high-dimensional data to a validator result 121. In these cases, the data analysis system 100 allows users to write an additional validator module 118 for the data type.

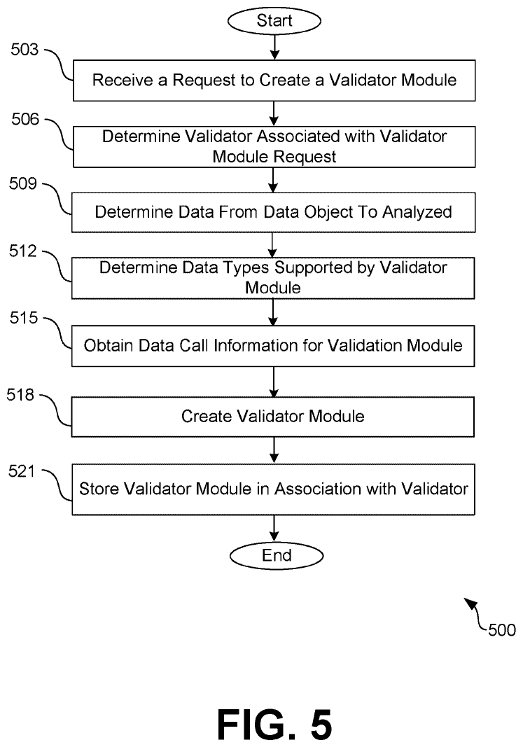

According to various examples, when creating a new validator method or module, a new class that extends from the base validator 106 can be added. In various examples, the new class is added by a user interacting with the data analysis system. To create the validator module 118, the following information would be required: (1) what part of the data object does it need (e.g., test, split, inference etc.); (2) the data types that it supports (e.g., time series, continuous, categorical, multidimensional, etc.); (3) the setting up for each module call (e.g., writing the normal test in off the shelf libraries); and (4) defined data calls from the validator 106 using the options that may be included in the validation schema 103. In various example, a user interacting with the client device 206 in communication with the data analysis engine 115 can create the new validator module 118 by providing the required information. FIG. 5 provides additional discussion regarding the addition of a validator module 118.

One design challenge of the data analysis system 100 of the present disclosure relates to maximizing value for both casual and expert users by allowing an arbitrary degree of customizability and complexity in validation strategies without sacrificing usability. The ideal data validation pipeline is arbitrarily customizable but also works as an out-of-the-box solution that can sit inline in a machine learning pipeline with minimal configuration. In light of this design challenge and the overall goal, the data analysis system 100 of the present disclosure supports the following of design principles: (1) maximally abstracting design details, (2) providing sensible, overridable defaults to provide out-of-the-box functionality; and (3) ease of method extensibility.

In order to use the analysis system of the present disclosure, casual users only need to know what they are trying to evaluate in their data. As such, they should not need to be able to identify or understand the underlying methods that check for these evaluations. For example, consider a user trying to perform anomaly detection. Users can toggle this functionality on and off with a single line of code, without considering the data types in their data or knowing anything about anomaly detection methods. To accomplish this, the data analysis system of the present disclosure divides the validation functionality into a modular, implementation-heavy component referred to as a validator module 118 and an easily toggleable component referred to as a validator 106.

A validator method or module comprises executable code that, when executed, performs a specific type of test for a data issue on a specific data type. These validator methods primarily consist of the code needed to take a dataset and run an evaluation on it that produces either a positive or negative result. Some examples of validator methods include: (1) Mann-Whitney U-Test to examine distribution shift between train/test splits on tabular data, (2) Kernel Conditional Independence (KCI) test for validating causal assumptions on vector valued data, (3) Isolation forest trained/evaluated on image histograms for identifying anomalies in imaging data, and/or other types of methods or modules.

Each toggleable component is referred to as a validator, and these are data type-agnostic collections of validator methods that are serially applied to the dataset. Each validator targets a single problem that may arise in data, including, for example, shifts between different data splits, outlier and anomaly detection, violation of parametric assumptions on the data, violation of expected casual structures/conditional independences in the data, and/or other type of problems.

According to various embodiments, the data analysis system 100 of the present disclosure is able to run out-of-the-box with minimal setup on the datasets users use in their pipeline. In various examples, the data analysis system 100 further provides options to override these defaults to accommodate the needs of expert users. In various examples, each validator 106 may include a default inclusion attribute based at least in part on whether the validator 106 should be included in the out-of-the-box validation setup associated with the validator system.

According to various examples, validators 106 can comprise specifications of what methods or validator modules 118 should be used by default to check for a given issue. However, if not all validator modules 118 in a validator 106 are desired for a given situation, users can write custom validators 106 with their own set of validator modules 118. When a validator 106 is being applied to a dataset, the backend of the data analysis system 100 by default applies every validator module 118 written for a particular data type to every column of that data type in the dataset 109. However, this behavior can also be overridden by including regular expressions for each validator module 118 to restrict the set of columns that the validator module 118 is applied to, which is helpful for working with large datasets 109 with regular column names. The result of all of these default options is a system that can be run optionless but can also be set up to behave exactly as the user desires.

According to various examples, ease of module extensibility ensures that users are not limited by the set of existing validator modules 118 and can easily integrate a new validation (e.g., validator module 118) into the framework of the data analysis system 100 without expending more time than it would take to write a standalone validator module 118. In addition, the modularity and extensibility increases the size and comprehensiveness of ready-to-go validator modules 118 that can be incorporated into a validation schema 103 with a single line of code. For example, users interacting with the data analysis engine 115 can create additional validator modules 118 and these created validator modules 118 can be stored to the data store 215 with respect to a corresponding validator 106 for future use by the user and/or other users of the data analysis engine 115. As such, users may be incentivized to contribute to help build the validator module 118 and validator 106 ecosystem implemented in the data analysis system 110.

In various examples, the ease of extensibility of the present disclosure is most evident in the modular design of the validator module 118 that are applied to each dataset 109. These validator module 118 comprise functional static classes that are scoped to apply a single method to a small number of data types. Validator modules 118 explicitly do not include suggestions for resolution of data-related issues. Enforcing the inclusion of potential solutions to these data-related issues would come at a heavy cost to ease of extensibility, which would hinder the degree to which users are able to write and share their own methods. Furthermore, once data-related issues become known, there are typically a number of paths forward for the user to increase performance in the model by appropriately modifying their experimental setup, and choosing the right path is a nuanced decision best left to the user.

In various examples, validator modules 118 return a validator result 121 that is interpretable and actionable. For example, validator modules 118 that comprise statistical components can yield a p-value under the null hypothesis that there is no problem with the data. Validator modules 118 that comprise scoring components such as, for example, anomaly detection methods, can return internal anomaly scores as well as the rankings of each sample in the dataset so that users can glance at the most suspicious examples and take appropriate action. Out of distribution (OOD) validator modules 118 applied at inference time can provide where the OOD score falls within the context of the training set.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

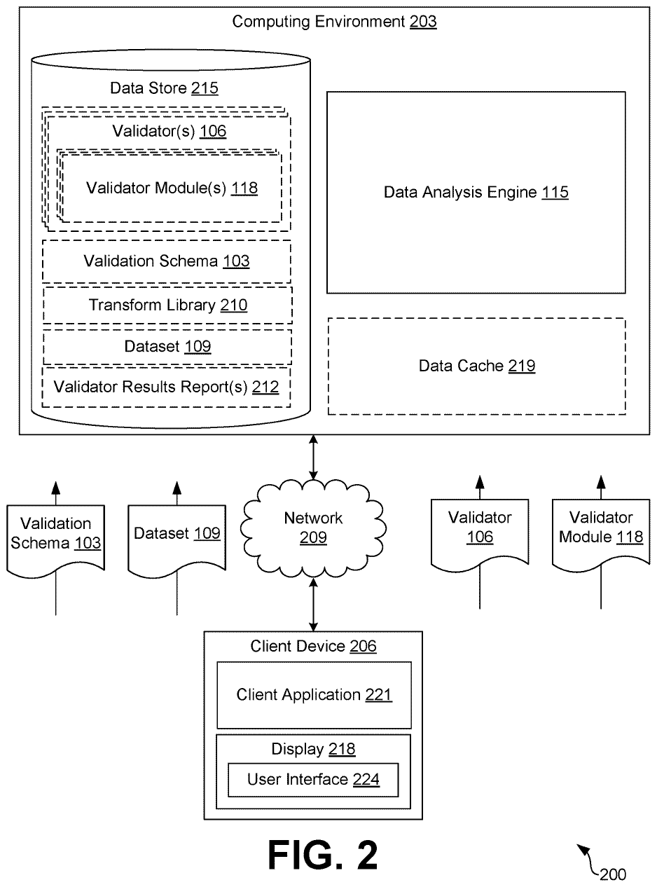

With reference to FIG. 2, shown is a network environment 200, according to various embodiments. The network environment 200 can include a computing environment 203 and a client device 206, which can be in data communication with each other via a network 209. The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource, an edge computing resource, or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a data analysis engine 115, and other applications, services, processes, systems, engines, or functionality not discussed in detail herein.

The data analysis engine 115 can be executed to analyze data included in a provided dataset 109 to detect any issues that may be present in the dataset 109. In various examples, the data analysis engine 115 can obtain a data object 112 comprising the dataset 109, a mapping defining the types of data included in the dataset 109, any splits (e.g., inference data, test data, training data, etc.) associated with the dataset 109, and/or other information. In addition, the data analysis engine 115 can obtain a validation schema 103 that can be used to define the types of validators 106 to use to evaluate the data included in the dataset 109.

In various examples, the validation schema 103 can include a list of the validators 106 that are to be used to analyze the data. In various examples, a validator 106 comprises a parametric assumptions validator, a conditional independence validator, a distribution shift validator, an anomaly validator, an out of distribution (ood) inference validator, and/or other type of validator. In some examples, the validators 106 can be predefined. In other examples, the validators 106 can be user defined and generated based at least in part on interactions by a user with the data analysis engine 115.

In some examples, the validation schema 103 can include options associated with the use of a validator 106 with regard to the data included in the dataset 109. For example, the validation schema 103 can further define the columns of the dataset 109 associated with the data that is to be analyzed or otherwise include the columns of the dataset 109 that are not to be evaluated, thereby providing filter properties associated with the testing. The validation schema 103 can further include other information that can be used by the data analysis engine 115 to select and execute the validator modules 118.

In various examples, each validator 106 can be associated with one or more validator modules 118 that are configured to analyze data included in the dataset 109 that is associated with one or more different data types. For example, the data included in the dataset 109 can include time-series data, continuous data, categorical data, multidimensional data, and/or other type of data. A validator module 118 associated with a given validator 106 can be configured to analyze one or more of the different data types. For example, a first validator module 118 associated with a first validator 106 can be configured to evaluate continuous data and multidimensional data but not time-series data or categorical data.

According to various examples, the data analysis engine 115 can select the validators 106 for data analysis of the dataset 109 based at least in part on the validation schema 103. Upon selecting the appropriate validators 106, the data analysis engine 115 can select the validator modules 118 associated with the validator 106 based at least in part on the type of data to be evaluated. The type of data to be evaluated can be determined in a mapping included with the dataset 109 that identifies the type of data for a given column in the dataset 109.

Upon selecting the validators 106 and validator modules 118 for analyzing the data, the data analysis engine 115 can execute the various validator modules 118 to determine the validator results 121 of FIG. 1 that are included in the output of the various validator modules 118 for the data included in the dataset 109. In various examples, the validator results can comprise a probability value and/or a scored value based on the type of test of a given validator module 118. In the example of scored values, the scored data can be ranked and the ranking can be included in validation result output.

In some examples, the data analysis engine 115 can generate a validator results report 212 that includes the validator results 121 associated with each of the executed validator modules 118. In some examples, the validator results report 212 includes the validator results 121 associated with each of the validator modules 118 that were executed for the corresponding data that was evaluated. In other examples, the validator results report 212 includes the aggregated validator results 124 of FIG. 1 that correspond to an aggregation of the validator results 121 for the validator modules 118 for a given validator 106. In this example, the aggregated validator results 124 can provide a more precise summary of the data results and highlight the areas in the data that may contain issues that need to be addressed. In various examples, the data analysis engine 115 can cause the validator results report 212 to be rendered on a display device of a client device 206 or other computing device.

Also, various data is stored in a data store 215 that is accessible to the computing environment 203. The data store 215 can be representative of a plurality of data stores 215, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 215 is associated with the operation of the various applications or functional entities described below. This data can include validators 106, a validation schema 103, a transform library 210, a dataset 109, a validator results report 212, and potentially other data.

Validators 106 comprises components that target a single problem that may arise in data, including, for example, shifts between different data splits, outlier and anomaly detection, violation of parametric assumptions on the data, violation of expected casual structures/conditional independencies in the data, and/or other type of problems. According to various examples, a validator 106 can comprise a parametric assumptions validator, a conditional independence validator, a distribution shift validator, an anomaly validator, an out of distribution (ood) inference validator and/or other type of validator. Each validator 106 comprises data type-agnostic collections of validator modules 118 that are serially applied to the dataset 109.

A validator module 118 comprises executable code that, when executed, performs a specific type of test for a data issue on a specific data type. In particular, a validator module 118 is configured to analyze the data included the dataset 109 based at least in part on the data modality and/or type of data (e.g., time series, continuous, categorical, multidimensional, etc.) being analyzed. These validator modules 118 primarily consist of the code needed to take a dataset 109 and run an evaluation on it that produces either a positive or negative result. Some examples of validator modules 118 include: (1) Mann-Whitney U-Test to examine distribution shift between train/test splits on tabular data, (2) Kernel Conditional Independence (KCI) test for validating causal assumptions on vector valued data, (3) Isolation forest trained/evaluated on image histograms for identifying anomalies in imaging data, and/or other types of methods or modules. In various examples, each executed validator module 118 can return validator results 121 associated with the corresponding analysis associated with the validator module 118.

According to various examples, validator modules 118 designed to examine distribution shifts between data splits can provide a p-value under the null hypothesis that the data from two data splits (e.g., train, validation, test, inference) are drawn from the same distribution. Similarly, for pointwise OOD tests, the data analysis system 100 can accept the training/validation sets and the data points the model is being used on and output (1) a set of the underlying OOD scores from the model outputs in the context of the training set and (2) a ranking of the samples by their likelihood of being anomalous. In some examples, where the inference data sets are significantly smaller than the training data sets, the validator modules 118 can provide a percentile value indicating where a data point's anomaly score would be placed as a percentile in the context of a larger dataset.

In various examples, a validator 106 and corresponding validator modules 118 can perform anomaly detection. In some examples, because it is unexpected for users to provide labeled anomalous samples, the validator modules 118 for the anomaly detection validator 106 can comprise unsupervised anomaly detection methods due to the scarcity of labeled anomalies in the wild. In one example, a number of out-of-the-box unsupervised anomaly detection methods from pyOD, an open-source anomaly detection toolkit, can be used to identify a variety of different types of anomalies over tabular data. In addition, for high-dimensional data such as images or audio, a lower dimensional representation using one of the aforementioned strategies can be used to make use of the set of validator modules 118 for multidimensional data. In various examples, anomaly detection is supported for aligned time-series data, multidimensional data, and continuous data.

In various examples, a validator 106 and corresponding validator modules 118 can evaluate data imbalance. When dealing with categorical and continuous data, it is possible that certain categorical and continuous variables exhibit an unusual amount of imbalance. Although there are a number of methods to manage data imbalance during model development, it is easy for data imbalances to slip through the cracks and silently compromise model performance. According to various examples, one or more of validator modules 118 of the data analysis system 100 of the present disclosure can implicitly check for class and continuous imbalances and warn users about these issues before training a model.

In various examples, a validator 106 and corresponding validator modules 118 can evaluate data with regard to parametric and statistical assumptions. Although one example use case for the data analysis system 100 is in heterogeneous machine learning settings, the assumption validation stage may prove especially useful for statistical models that have a number of strong assumptions on the underlying data, such as parametric assumptions or some other form of distributional adherence. Other data-related assumptions, such as linearity and equality of variance, can also be quickly and easily checked by the data analysis system according to various examples.

In various examples, a validator 106 and corresponding validator modules 118 can evaluate data with regard to causal/conditional independence assumptions. Causal and conditional independence assumptions are especially useful in machine learning settings where some level of inductive knowledge around the causal structure of the data or the data generating process exists. These types of assumptions can be useful in tabular settings where causal structure is already known.

In various examples, a user can create validators 106 and/or corresponding validator modules 118 that can be transmitted from the client device 206 to the data analysis engine 115. For example, users can interact with a user interface 224 associated with the data analysis engine 115 and define the functionality of a validator 106 and/or associated validator module 118 via code. Accordingly, the validator 106 and/or associated validator module 118 can be transmitted from the client device 206 to the data analysis engine 115.

The validation schema 103 comprises data defining the validators 106 (e.g., 106a, 106b, 106c, 106d, 106e) for analyzing a dataset 109 and a data object 112 defining the dataset 102 and splits of the dataset (e.g., training dataset, validation dataset, testing dataset, inference dataset, etc.) can be provided to a data analysis engine 115. In various examples, the validation schema 103 can include a list defining at least a subset of a plurality of validators 106 that can be used to analyze the dataset 109. In some examples, the validation schema 103 can include options associated with the use of a validator 106 with regard to the data included in the dataset 109. For example, the validation schema 103 can further define the columns of the dataset 109 associated with the data that is to be analyzed or otherwise include the columns of the dataset 109 that are not to be evaluated, thereby providing filter properties associated with the testing. In some examples, the validation schema 109 can include information defining one or more data-specific transformations that may be required to transform all columns of one data type included in the dataset 109 into another data type. For example, the validation schema 109 can identify one or more representation functions (e.g., word2vec or ResNet encoders) that map each data modality to a multidimensional continuous vector that contains a compressed representation of the data modality and then use a set of existing multidimensional validator methods to perform all of the data analysis system's checks.

The validation schema 103 can further include other information that can be used by the data analysis engine 115 to select and execute the validator modules 118. In various examples, the validation schema 103 is user defined. In other examples, a validation schema 103 can be predefined. Accordingly, in some examples, a validation schema 103 can be selected from a plurality of predefined validation schemas 103 based at least in part on the type of evaluation desired for a given type of dataset 109.

In some examples, the validation schema 103 can be empty or indicate a default option, and therefore not define any of the plurality of validators 106 that can be used to analyze the dataset 109. In this example, the data analysis engine 115 can select validators 106 that can be automatically applied based at least in part on the dataset 109 being analyzed.

The transform library 210 can include predefined transformation functions that allow the data to be effectively transformed from an unsupported data type to a supported data type. In some examples, the transform functions can map each data modality to a multidimensional continuous vector that contains a compressed representation of the data modality and then use a set of existing multidimensional validator methods to perform all of the data analysis system's checks. In other examples, the transform functions can map the data included in the dataset 109 from high dimensional feature spaces (e.g., images, audio data, etc.) to a low-dimensional descriptive representations (e.g., a histogram, bandlimited spectrograph, etc.).

The dataset 109 can include data that represents information (e.g., measurements, statistics, etc.) associated with one or more objects that can be stored electronically. In various examples, the dataset 109 can include time series data, continuous data, categorical data, multidimensional data and/or another type of data. In various examples, the dataset 109 can comprise a torch dataset describing the data type of each of its columns. In some examples, the dataset 109 may need to be preprocessed and split, as this allows the data analysis engine 115 to find mistakes from the preprocessing stage (e.g., miscoding errors) or the splitting stage (e.g., splits that are not independent and identically distributed (IID)). In some examples, the dataset 109 can be associated with a data object 112 that defines the dataset 109 and splits of the dataset (e.g., training dataset, validation dataset, testing dataset, inference dataset, etc.) mapping each column to its data type.

The validator results report 212 includes the validator results 121 associated with each of the executed validator modules 118. In some examples, the validator results report 212 includes the validator results 121 associated with each of the validator modules 118 that were executed for the corresponding data that was evaluated. In other examples, the validator results report 212 includes aggregated validator results 124 that correspond to an aggregation of the validator results 121 for the validator modules 118 for a given validator 106. In this example, the aggregated validator results 124 can provide a more precise summary of the data results and highlight the areas in the data that may contain issues that need to be addressed. In various examples, the data analysis engine 115 can cause the validator results report 212 to be rendered on a display device of a client device 206 or other computing device.

The computing environment 203 can further include a data cache 219. The data cache 219 can store transformed data that has been output from a given transformation function. According to various examples, data included in the dataset 109 can be transformed into one or more types of data using transformation functions included in the transform library 210 and/or included and defined in the validation schema 103. Once the data is transformed, the transformed data can be stored in the data cache 219. Accordingly, as different validators modules 118 are executed on the data, the transformed data can be accessed from the data cache 219 instead of having to recompute the transforms each time a validator module 118 is applied and/or a different data split is analyzed.

The client device 206 is representative of a plurality of client devices that can be coupled to the network 209. The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 206 can include one or more displays 218, such as liquid crystal displays (LCDs), gas plasma-based flat panel displays, organic light emitting diode (OLED) displays, electrophoretic ink (“E-ink”) displays, projectors, or other types of display devices. In some instances, the display 218 can be a component of the client device 206 or can be connected to the client device 206 through a wired or wireless connection.

The client device 206 can be configured to execute various applications such as a client application 221 or other applications. The client application 221 can be executed in a client device 206 to access network content served up by the computing environment 203 or other servers, thereby rendering a user interface 224 on the display 218. To this end, the client application 221 can include a browser, a dedicated application, or other executable, and the user interface 224 can include a network page, an application screen, or other user mechanism for obtaining user input. The client device 206 can be configured to execute applications beyond the client application 221 such as email applications, social networking applications, word processors, spreadsheets, or other applications.

It should be noted that although FIG. 2 illustrates the data analysis engine 115 being executed as a back-end system within the computing environment 203, it should be noted that in some examples, the data analysis engine 115 can comprise a standalone system or an extension component that can be incorporated in a client device 206. Accordingly, some or all of the functionality and components of the computing environment can be included or otherwise performed by the client device 206.

Next, a general description of the operation of the various components of the network environment 200 is provided with regard to an example case study. In order to show the value of the data analysis system 100 in action, the data analysis system 100 of the present disclosure was applied to a variety of different medical datasets 109 in a case study. This case study is intended to represent the conditions of a highly multimodal environment in which the user is querying data from a significant number of different datasets 109 across different modalities. In medical research, it is often necessary to examine a number of different types of data modalities (e.g., imaging, genetic data, demographic data, sequencing data, etc.) from a number of different sources. The datasets 109 of the case study were selected to imitate this case.

In this case study, a number of different datasets 109 were considered. The different datasets 109 included a number of breast cancer datasets, a cardio dataset, a lymphography dataset, a thyroid dataset, and a molecule dataset containing molecular attributes. The included datasets 109 contained both categorical and continuous data, as well as both univariate and multivariate data, and pertain to a number of different disease types and collected analyses. During evaluation, the binary categorical data was included in a multidimensional data vector. There was no nonbinary categorical data included in this evaluation.

For each dataset 109, twenty (20) samples were taken and held out from the dataset 109 to be used at “inference time”; these samples are meant to represent online data that the model would encounter at inference time after training and deployment. The remainder of the dataset (the “all-but-inference” set) was used to perform a random split of 60/20/20 to recover the train, validation, and test datasets. All of these datasets—the inferences dataset, the “all-but-inference” dataset, the train dataset, the validation dataset, the test dataset, and the entire dataset—were included in the data object 112 that was input to the data analysis engine 115.

Three validators 106 were selected to be executed by the data analysis engine 115 based at least in part on a validation schema 103, the dataset 109, and the data object 112 received by the data analysis engine 115. For example, a validation schema 103 defining the types of validators 106 to run on the dataset 109 can be received by the data analysis engine 115 from a client device 206, from a data store 215 including one or more predefined validation schemas 103, and/or other entity. In various examples, the data analysis engine 115 can identify the validator modules 118 associated with the validators 106 based at least in part on the data types included in the dataset 109 which may be defined by the dataset 109 and/or a corresponding data object 112.

These validator modules 118 checked for anomalous samples in an unsupervised fashion; distribution shift between the train, test, and validation datasets; and potential out-of-distribution issues at inference time. To detect anomalous samples, a number of validator modules 118 from ADBench were used, including Principal Component Analysis (PCA) outlier detection, isolation forests, and the Cluster-Based Local Outlier Factor (CBLOF) anomaly detection algorithm. To detect dataset shift, a number of statistical validator modules 118 including a two-sample Kolmogorov-Smirnov test, a Mann-Whitney U-Test, and a Kruskal-Wallis test were executed. The p-value for distribution shift for multivariate data was adjusted with a Bonferroni correction. Results from the validator modules 118 associated with anomaly detection validator 106 are illustrated in Table 1. The best performing anomaly detection varied between the different types of datasets, which suggests that it is important to use a variety of different validator modules 118.

TABLE 1
Anomaly Detection Method/Module Predictive Performance
for each Dataset (AUCROC). Dataset displayed as
dataset name (n = anomaly count/dataset size).

| | Dataset | | | Validator Modules | |
|---|---|---|---|---|---|
| | cblof | iforest | pca | rank agg | rank avg |
| breastw (n = 239/683) | 0.964 | 0.986 | 0.959 | 0.984 | 0.984 |
| cardio (n = 176/1831) | 0.739 | 0.932 | 0.950 | 0.894 | 0.894 |
| Lymphography (n = | 0.996 | 0.999 | 0.996 | 0.998 | 0.998 |
| 6/148) | | | | | |
| musk (n = 97/3062) | 1.000 | 1.000 | 1.000 | 1.000 | 1.000 |
| thyroid (n − 93/3772) | 0.935 | 0.979 | 0.955 | 0.960 | 0.960 |
| WBC (n = 10/223) | 0.968 | 0.995 | 0.994 | 0.990 | 0.990 |
| WDBC (n = 10/367) | 0.999 | 0.988 | 0.986 | 1.000 | 1.000 |

To detect out-of-distribution samples at inference, the aforementioned anomaly detection validator modules 118 were used by training them on all but the twenty held out samples, applying the validator modules 118 to the twenty samples in the inference dataset, and evaluating them on the provided anomaly labels. In the example case study, no statistically significant results indicating shift between training data, validation data, and test data were detected. The OOD at inference validator results 121 from these tests are shown in Table 2.

TABLE 2
OOD at Inference Predictive Performance for each
Dataset (AUCROC). Dataset displayed as dataset
name (n = anomaly count/dataset size).

| | Dataset | | | Validator Modules | |
|---|---|---|---|---|---|
| | cblof | iforest | pca | rank agg | rank avg |
| breastw (n = 239/683) | 1.000 | 1.000 | 0.929 | 1.000 | 1.000 |
| cardio (n = 176/1831) | 0.947 | 0.947 | 0.947 | 0.947 | 0.947 |
| Lymphography (n = | 1.000 | 1.000 | 1.000 | 1.000 | 1.000 |
| 6/148) | | | | | |
| musk (n = 97/3062) | 1.000 | 1.000 | 1.000 | 1.000 | 1.000 |
| thyroid (n − 93/3772) | 0.895 | 0.947 | 0.947 | 0.947 | 0.947 |
| WBC (n = 10/223) | 1.000 | 0.947 | 0.947 | 0.947 | 0.947 |
| WDBC (n = 10/367) | 1.000 | 1.000 | 1.000 | 1.000 | 1.000 |

To examine the relationship between each validator module 118 for anomaly detection, the Spearman correlation between the rank vectors from each validator module 118 was observed. The results from the rank average and a Borda count rank aggregation method were also included. It was determined that the five ranking validator modules 118 exhibited a mean correlation of r=0.853. This suggests that the rankings between validator modules 118 each contain a unique source of information.

According to various examples, each validator module 118 (e.g., isolation forest, pca, and cblof) scored each sample in each dataset 109 for anomalous content in the test case. These scores were converted into a list of “anomaly ranks” over each sample in the dataset 109. Then, the data analysis engine 115 aggregated those ranks by (a) averaging them and (b) using Borda count ranking. In some datasets 109 and validator modules 118 (e.g., pca/iforest in cardio dataset), there was some amount of redundancy between validator modules 118, but in the majority of cases, the anomaly validator modules 118 showed a nontrivial amount of misalignment, indicating the need for multiple detection methods. In the test case, there was not a substantial difference between Borda count rank aggregation and rank averaging.

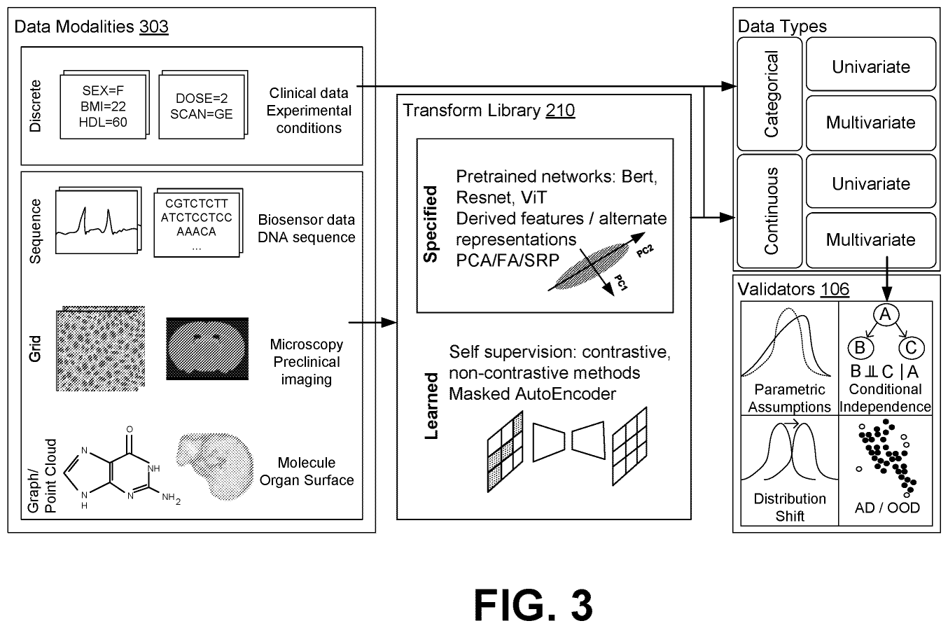

Turning now to FIG. 3 shown is an example drawing illustrating how it can be possible to leverage the wealth of multidimensional data validator modules 118 with a single representation function per data modality 303. A data modality 303 can comprise discrete data, sequence data, grid data, graph/point cloud data, and/or other types of data modalities. In various examples of the present disclosure, the data analysis engine 115 can apply dimensionality reduction and representation learning techniques to map a wide array of data modalities 303 to a vector representation. According to various examples, FIG. 3 illustrates how various forms of data can be analyzed using different types of validators 103. For example, data having a discrete-based data modality 303 can correspond to a categorical data type. The data analysis engine 115 can then determine whether the data is univariate or multivariate and select an appropriate validator 106 and validator modules 118 to use to evaluate the data. Similarly, data representing a point cloud-based data modality 303 can be transformed using machine learning transforms included in the data library 210. The transforms can transform the data into a vector representation which can then be further analyzed by a validator 106 and corresponding validator module 118 based at least in part on the type of data represented by the vector.

In various examples, the data that is transformed by the transforms in the transform library 210 and/or by transforms provided in the validation schema 103 can be stored in a data cache 219. In this example, while the data may be transformed and analyzed by a validator 106 and corresponding validator module 118, the transformed data can be obtained from the data cache 109 for subsequent analysis by other validators 106 and/or validator modules 118. As such, data analysis can be performed on different data subsets or splits without needing to recompute the transforms.

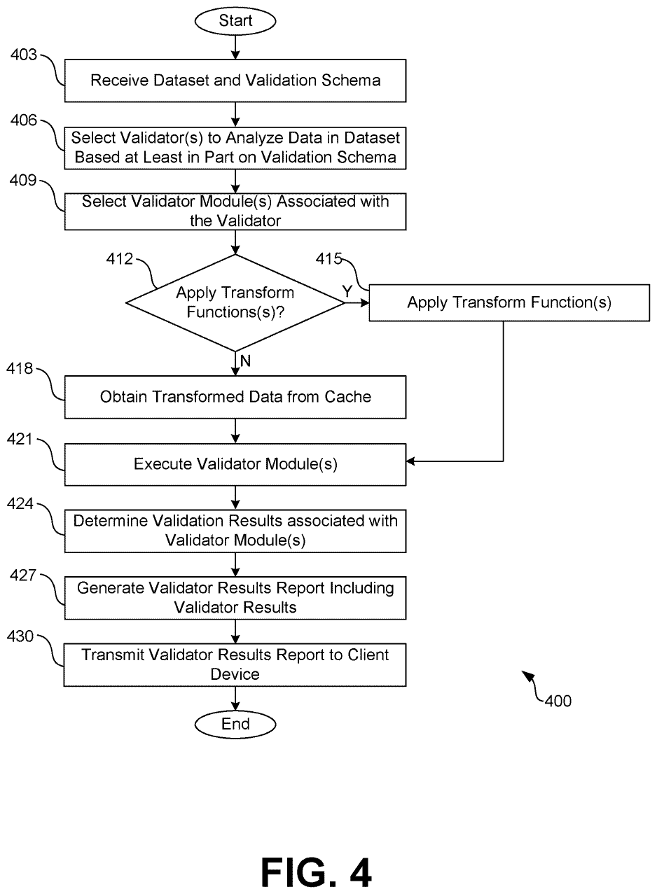

Referring next to FIG. 4, shown is a flowchart 400 that provides one example of the operation of a portion of the data analysis engine 115. The flowchart of FIG. 4 provides merely an example of the many different types of functional arrangements that can be employed to implement the operation of the depicted portion of the data analysis engine 115. As an alternative, the flowchart of FIG. 4 can be viewed as depicting an example of elements of a method implemented within the network environment 200.

In particular, FIG. 4 relates to facilitating customizable and modular analysis of a dataset 109 using a validator 106 defined in a validation schema 103 in accordance with the framework of the data analysis system 100. To overcome the shortcomings of known data validation techniques, the present disclosure relates to a modular, extensible data validation framework that seeks to identify data-related issues in real world data. The use of validators 106 and corresponding validator modules 118 of the data analysis system 100 provide an effective and extensible tool for discovering the problems that one might encounter in real-world datasets that are potentially noisy, heterogeneous, sparse, multimodal, miscoded, and preprocessed incorrectly validator modules 118.

In various examples, the use of the validators 106, validator modules 118 and ability to define what to test using the validation schema 103 maximize value for both casual and expert users by allowing an arbitrary degree of customizability and complexity in validation strategies without sacrificing usability. In various examples, the validation framework is arbitrarily customizable but also works as an out-of-the-box solution that can sit inline in a machine learning pipeline for high dimensional data with minimal configuration. Accordingly, the data analysis system 100, as described in FIG. 4, supports the following of design principles: (1) maximally abstracting design details, (2) providing sensible, overridable defaults to provide out-of-the-box functionality; and (3) ease of method extensibility.

In order to use the analysis system 100 of the present disclosure as, casual users only need to know what they are trying to evaluate in their data. As such, they should not need to be able to identify or understand the underlying methods that check for these evaluations. For example, consider a user trying to perform anomaly detection. Users can toggle this functionality on and off with a single line of code, without considering the data types in their data or knowing anything about anomaly detection methods. In various examples, this can be included when defining the validation schema 103. To accomplish this, the data analysis system of the present disclosure divides the validation functionality into a modular, implementation-heavy component referred to as a validator module 118 and an easily toggleable component referred to as a validator 106.

Beginning with box 403, the data analysis engine 115 receives a dataset 109 and a validation schema 103. In various examples, data analysis engine 115 receives the dataset 109 and/or the validation schema 103 from a client device 206. For example, the data analysis engine 115 can receive the dataset 109 and the validation schema 103 from the client device 206 in response to one or more user interactions with a user interface 224 associated with the data analysis engine 115 that is rendered on the client device 206. For example, users can define the type of validators 106 to use by toggling the functionality associated with the desired validator 106 on and off with a single line of code or user interaction with a user interface 224, without considering the data types in their data or knowing anything about the associated validator modules 118. In some examples, the dataset 109 and/or the validation schema 103 are received with a request to analyze data in the dataset 109. In various examples, requests can include the dataset 109 and/or the validation schema 103. In other examples, the request can include a data store location for accessing the dataset 109 and/or the validation schema 103.

In various examples, the dataset 109 can include time series data, continuous data, categorical data, multidimensional data and/or another type of data. In various examples, the dataset 109 can comprise a torch dataset describing the data type of each of its columns. In some examples, the dataset 109 may need to be preprocessed and split, as this allows the data analysis engine 115 to find mistakes from the preprocessing stage (e.g., miscoding errors) or the splitting stage (e.g., splits that are not independent and identically distributed (IID)). In some examples, the data analysis engine 115 receives a data object 112 from the client device 206. In various examples, the dataset 109 can be associated with the data object 112. The data object 112 defines the dataset 109 and one or more splits of the dataset (e.g., training dataset, validation dataset, testing dataset, inference dataset, etc.). In various examples, the data object 112 can include a mapping of each column of the dataset 109 to its respective data type (e.g., time-series, continuous, categorical, multidimensional, etc).

In various examples, the validation schema 103 comprises data defining at least a subset of validators 106 to use for analyzing the dataset 109 and a data object 112 defining the dataset 109. In some examples, the data object 112 can define splits of the dataset 109. In various examples, the validation schema 103 can include a list of the validators 106 that are to be used to analyze the dataset 109. In some examples, the validation schema 103 can include options associated with the use of a validator 106 with regard to the data included in the dataset 109. For example, the validation schema 103 can further define the columns of the dataset 109 associated with the data that is to be analyzed or otherwise include the columns of the dataset 109 that are not to be evaluated, thereby providing filter properties associated with the testing. In some examples, regular expressions can be used to facilitate column selection.

The validation schema 103 can further include other information that can be used by the data analysis engine 115 to select and execute the validator modules 118. In various examples, the validation schema 103 is user defined. For example, the validation schema 103 can be user-defined in response to a user interaction with a user interface 224 rendered on a client device 206, the user interaction comprising a selection of a validator component associated with the validator 106. In various examples, the validator 106 defined in the validation schema 103 comprises a plurality of validator modules 118. In various examples, the plurality of validator modules 118 associated with validator 106 defined in the validation schema 118 can be unknown to the user. In various examples, the ability for the user to define the validation schema 103 without the knowledge of the associated validator modules 118 allows an arbitrary degree of customizability and complexity in validation strategies without sacrificing usability. In other examples, a validation schema 103 may be predefined. Accordingly, in some examples, a validation schema 103 can be selected from a plurality of predefined validation schemas 103 based at least in part on the type of evaluation desired for a given type of dataset 109.

In some examples, the validation schema 103 can be empty or indicate a default option, and therefore not define any of the plurality of validators 106 that can be used to analyze the dataset 109. In this example, the data analysis engine 115 can select validators 106 that can be automatically applied based at least in part on the dataset 109 being analyzed.

At box 406, the data analysis engine 115 selects a validator(s) 106 to analyze the data in the dataset 109 based at least in part on the validation schema 103. In various examples, the validation schema 103 defines at least a subset of a plurality validators 106 for an analysis of the data included in the dataset 109. The selected validator 106 is one of the plurality of validators and is included in the subset of the plurality of validators 106. In various examples, the validator 106 comprises one of a parametric assumptions validator, a conditional independence validator, a distribution shift validator, an anomaly validator, an out of distribution (ood) inference validator, and/or other type of validator. In some examples, the validation schema 103 can include multiple validators 106 that are to be used for the analysis of the provided dataset 109. Accordingly, the data analysis engine 115 can select multiple validators 106 based at least in part on the list of validators 106 included in the validation schema 103.

At box 409, the data analysis engine 115 selects a validator module 118 associated with the selected validator 106. In some examples, the validator module 118 is selected based at least in part on the data type of the data in the dataset 109 being analyzed, the data splits associated with the data set 109, inclusion criteria defined in the validation schema 103, a column name of the data to be analyzed, and/or other factors. In particular, a validator module 118 is configured to analyze the data included the dataset 109 based at least in part on the data modality, the type of data being analyzed, inclusion criteria defined in the validation schema 103, and/or other factor The data type of the data being analyzed can comprises time series data, continuous data, categorical data, multidimensional data, and/or another type of data. These validator modules 118 primarily consist of the code needed to take a dataset 109 and run an evaluation on it that produces a validator result 121. In some examples, the validation schema 103 defines the type of data to be analyzed. In some examples, the data object 112 received with the dataset 109 defines the type of data and/or data splits that are included in the dataset 109. Each validator 106 comprises data type-agnostic collections of validator modules 118 that are serially applied to the dataset 109. In some examples, the validator module 118 is one of a plurality of validator modules 118 that are associated with the validator 106. In various examples, individual validator modules 118 associated with the validator 106 are configured to analyze at least one of a plurality of data types (e.g., time-series, continuous, categorical, multidimensional, etc.). Accordingly, the data analysis engine 115 can select multiple validator modules 118 based at least in part on the data type of the data in the dataset 109 being analyzed and/or the data splits present in the dataset 109.

At box 412, the data analysis engine 115 determines whether the data needs to be transformed. For example, if the data has been previously transformed using transformation functions in the transformation library 210 and/or validation schema, the transformed data can be stored in the data cache 109 for subsequent use. As such, if the data has previously been transformed and the transformed data is stored in the data cache 109, the data analysis engine 115 determines the data does not need to be transformed and proceeds to box 418 where the data analysis engine 115 obtains the transformed data from the data cache 219. However, if the data analysis engine 115 determines that the data needs to be transformed, the data analysis engine 115 proceeds to box 415.

At box 415, the data analysis engine 115 applies the transform functions to transform the data to be applied to the given validator module 118. For example, the data analysis engine 115 can apply one or more data-specific transformation functions to transform all columns of one data type included in the dataset 109 into another data type that is supported by the given validator module 118. In some examples, the transformation functions can be included in the validation schema 109. In other examples, the transformation functions can be stored in a data store 215 in a transform library 210. For example, the transformation functions can be included in a transform library 210 that includes predefined transforms that allows the data to be effectively transformed from an unsupported data type to a supported data type. In some examples, the transform functions can map each data modality to a multidimensional continuous vector that contains a compressed representation of the data modality and then use a set of existing multidimensional validator methods to perform all of the data analysis system's checks. In other examples, the transform functions can map the data included in the dataset 109 from high dimensional feature spaces (e.g., images, audio data, etc.) to a low-dimensional descriptive representations (e.g., a histogram, bandlimited spectrograph, etc.). In various examples, the transformed data can be stored in a data cache 219 for subsequent use by other validators 106 and/or other validator modules 118.

At box 421, the data analysis engine 115 executes the validator module 118 to determine a validation result associated with the corresponding data of the dataset being analyzed by applying the corresponding data to the functions of the validator module 118. Validator module 118 comprises executable code that, when executed, performs a specific type of test for a data issue on a specific data type. Some examples of validator modules 119 include: (1) Mann-Whitney U-Test to examine distribution shift between train/test splits on tabular data, (2) Kernel Conditional Independence (KCI) test for validating independent assumptions on vector valued data, (3) Isolation forest trained/evaluated on image histograms for identifying anomalies in imaging data, and/or other types of methods or modules.

At box 424, the data analysis engine 115 determines the results associated with the validator module 118. In various examples, each executed validator module 118 can return validator results 121 associated with the corresponding analysis of the dataset 109 performed by the validator module 118. In some examples, the results comprise a probability value. In other examples, the results comprise a score and the tested data can be ranked according to the score.

At box 427, the data analysis engine 115 generates a validator results report 212 including the validator results 121. The validator results report 212 includes the validator results 121 associated with each of the executed validator modules 118. In some examples, the validator results report 212 includes the validator results 121 associated with the validator module 118 that was executed for the corresponding data that was evaluated. In other examples, the validator results report 212 includes aggregated validator results 124 that correspond to an aggregation of the validator results 121 for multiple validator modules 118 that were executed for a given validator 106. In this example, the aggregated validator results 124 can provide a more precise summary of the data results and highlight the areas in the data that may contain issues that need to be addressed.

At box 430, the data analysis engine 115 transmits the validator results report 212 to a client device 206 to be rendered on a display 218 of the client device 206. In some examples, the data analysis engine 115 transmits the validator results report 212 to a client device 206 which can render the validator results report 212 on a display 218 of the client device 206. For example, the data analysis engine 115 can generate a user interface 224 including the validator results report 212 or user interface code for generating the user interface 224 including the validator results report 212 and transmit the user interface 142 or user interface code to a client device 206. Thereafter, this portion of the process proceeds to completion.

Referring next to FIG. 5, shown is a flowchart 500 that provides one example of the operation of a portion of the data analysis engine 115. The flowchart of FIG. 5 provides merely an example of the many different types of functional arrangements that can be employed to implement the operation of the depicted portion of the data analysis engine 115. As an alternative, the flowchart of FIG. 5 can be viewed as depicting an example of elements of a method implemented within the network environment 200.

In particular, FIG. 5 relates to the ability for a user to create a new validator module 118 for use within the data analysis system framework in accordance to various embodiments. The ease of module extensibility ensures that users are not limited by the set of existing validator modules 118 and can easily integrate a new validation (e.g., validator module 118) into the framework of the data analysis system 100 without expending more time than it would take to write a standalone validator module 118. In addition, the modularity and extensibility increases the size and comprehensiveness of ready-to-go validator modules 118 that can be incorporated into a validation schema 103 with a single line of code.

The ease of extensibility of the present disclosure is most evident in the modular design of the validator module 118 applied to each dataset 109. A validator module 118 comprises functional static classes that are scoped to apply a single method to a small number of data types. Validator modules 118 explicitly do not include suggestions for resolution of data-related issues. Enforcing the inclusion of potential solutions to these data-related issues would come at a heavy cost to ease of extensibility, which would hinder the degree to which users are able to write and share their own methods. Furthermore, once data-related issues become known, there are typically a number of paths forward for the user to increase performance in the model by appropriately modifying their experimental setup, and choosing the right path is a nuanced decision best left to the user.

Beginning with box 503, the data analysis engine 115 receives a request to create a validator module 118. For example, the data analysis engine 115 can receive a request to create a validator module 118 from a client device 206 in response to a user interacting with a user interface 224 associated with the data analysis engine 115 that is rendered on the client device 206. In this example, a user may determine that a type of data analysis is not supported or otherwise included in the validator module 118 associated with a validator 106 that is obtainable by the data analysis engine 115. However, when the desired type of data analysis is not included in the validator modules 118 associated with a given validator 106, a user can request to create a new validator module 118 by creating a request via interactions with the user interface 224.

At box 506, the data analysis engine 115 determines a validator 106 associated with validator module request. For example, the request may identify the validator 106. In various examples, the validator 106 comprises a parametric assumptions validator, a conditional independence validator, a distribution shift validator, an anomaly validator, an out of distribution (ood) inference validator, and/or other type of validator 106.

At box 509, the data analysis engine 115 determines what part of a data object 112 is to be analyzed. A data object 112 defines the dataset 109 and splits of the dataset (e.g., training dataset, validation dataset, testing dataset, inference dataset, etc.) mapping each column to its data type. In this example, a user can define whether the validator module 118 being created uses the entire dataset 109, the training dataset, the validation dataset, the testing dataset, the inference dataset, and/or other portion of the dataset that is defined by the data object 112. In various examples, the data analysis engine 115 determines the part of the data object 112 to be analyzed by the created validator module 118 in response to one or more user interactions by the user interacting with a user interface 224 associated with the data analysis engine 115. In some examples, this information is included in the request. In other examples, this information is included in response to a prompt provided to the user and rendered via the user interface 224.

At box 512, the data analysis engine 115 determines the data types to be supported by the new validator module 118. For example, the new validator module 118 can support time series data, continuous data, categorical data, multidimensional data and/or other type of data. In various examples, the data analysis engine 115 determines the type of the data to be supported by the created validator module 118 in response to one or more user interactions by the user interacting with a user interface 224 associated with the data analysis engine 115. For example, the user can define the supported data types when creating the new validator module 118. In some examples, this information is included in the request. In other examples, this information is included in response to a prompt provided to the user and rendered via the user interface 224.

At box 515, the data analysis engine 115 determines the data call information for the validator module 118. In various examples, the data call information can include setting up the method calls including in the validator module. In some examples, this information includes calls to off the shelf libraries that can be used and/or executed to obtain the information required. In addition, this information can include configuration data that may define data calls from the validator 106 using options that may be included in the validation schema 103. In other examples, this information can include executable code provided by the user requesting the additional validator module 118. In various examples, the data analysis engine 115 determines the data call information for the validator module 118 in response to one or more user interactions by the user interacting with a user interface 224 associated with the data analysis engine 115. In some examples, this information is included in the request. In other examples, this information is included in response to a prompt provided to the user and rendered via the user interface 224.

At box 518, the data analysis engine 115 creates the validator module 118. In various examples, the validator module 118 is created using the obtained and/or determined information from boxes 506-515. This information includes, for example, (1) what part of the data object does it need (e.g., test, split, inference etc.); (2) the data types that it supports (e.g., time series, continuous, categorical, multidimensional, etc.); (3) the setting up for each module call (e.g., writing the normal test in off the shelf libraries); and (4) defined data calls from the validator 106 using the options that may be included in the validation schema 103.

At box 521, the data analysis engine 115 stores the validator module 118 in the data store 215 in association with the appropriate validator 106. Thereafter, this portion of the process proceeds to completion.

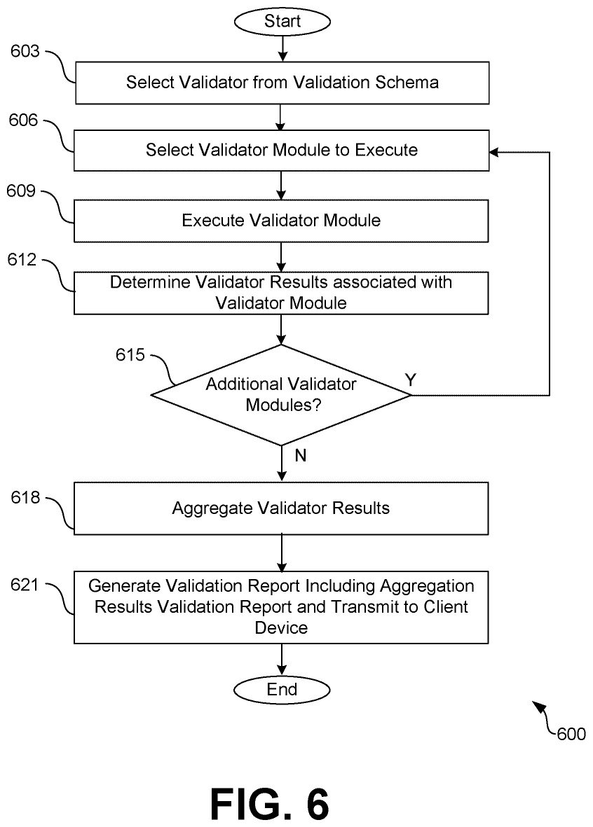

Referring next to FIG. 6, shown is a flowchart 600 that provides one example of the operation of a portion of the data analysis engine 115. The flowchart of FIG. 6 provides merely an example of the many different types of functional arrangements that can be employed to implement the operation of the depicted portion of the data analysis engine 115. As an alternative, the flowchart of FIG. 6 can be viewed as depicting an example of elements of a method implemented within the network environment 200.

In particular, FIG. 6 relates to generating aggregated validator results 124 based at least in part on the validator results 121 of the executed validator modules 118. According to various embodiments, users only need to know what they are trying to evaluate in their data, should not need to be able to identify or understand the underlying methods that check for these evaluations. As such, if multiple modules 118 for a given validator 106 are executed, the user may only need to know the aggregated results associated with the executed modules 118 and not results for each executed module 118.

Beginning with box 603, the data analysis engine 115 selects a validator 106 from a validation schema 103. In various examples, the validation schema 103 defines at least a subset of validators 106 for an analysis of the data included in a dataset 109. The selected validator 106 is one of the plurality of validators and is included in the subset of the plurality of validators 106. In various examples, the validator 106 comprises one of a parametric assumptions validator, a conditional independence validator, a distribution shift validator, an anomaly validator, an out of distribution (ood) inference validator, and/or other type of validator. In some examples, the validation schema 103 can include multiple validators 106 that are to be used for the analysis of the provided dataset 109. Accordingly, the data analysis engine 115 can select multiple validators 106 based at least in part on the list of validators 106 included in the validation schema 103.

At box 606, the data analysis engine 115 selects a validator module 118 associated with the selected validator 106. In some examples, the validator module 118 is selected based at least in part on the data type of the data in dataset 109, the data splits associated with the data set 109, inclusion criteria defined in the validation schema 103, a column name of the data to be analyzed, and/or other factors. In particular, a validator module 118 is configured to analyze the data included in the dataset 109 based at least in part on the data modality, the type of data (e.g., time series, continuous, categorical, multidimensional, etc.) being analyzed, inclusion criteria defined in the validation schema 103, and/or other factor. These validator modules 118 primarily consist of the code needed to take a dataset 109 and run an evaluation on it that produces a validator result 121. In some examples, the validation schema 103 can define the data to be analyzed. For example, the validation schema 103 can define the column name of the data to be analyzed, the data type of the data to be analyzed, the data splits to be analyzed, and/or other types of inclusion criteria that defines which data in the data set 109 is to be analyzed. In some examples, the data object 112 received with the dataset 109 defines the type of data that is included in the dataset 109. Each validator 106 comprises data type-agnostic collections of validator modules 118 that are serially applied to the dataset 109.

At box 609, the data analysis engine 115 executes the validator module 118 to determine a validation result associated with the corresponding data of the dataset being analyzed by applying the corresponding data to the functions of the validator module 118. Validator module 118 comprises executable code that, when executed, performs a specific type of test for a data issue on a specific data type. Some examples of validator modules 119 include: (1) Mann-Whitney U-Test to examine distribution shift between train/test splits on tabular data, (2) Kernel Conditional Independence (KCI) test for validating causal assumptions on vector valued data, (3) Isolation forest trained/evaluated on image histograms for identifying anomalies in imaging data, and/or other types of methods or modules.

At box 612, the data analysis engine 115 determines the results associated with the validator module 118. In various examples, each executed validator module 118 can return validator results 121 associated with the corresponding analysis of the dataset 109 performed by the validator module 118. In some examples, the results comprise a probability value. In other examples, the results comprise a score and the tested data can be ranked according to the score.

At box 615, the data analysis engine 115 determines whether there are additional validator modules 118 associated with the validator 106 to be executed. For example, a validator 106 may be associated with a plurality of validator modules 118 that support a particular type of data. In the example of FIG. 1, the validator modules 118a, 118b under validator 106a supported continuous data. As such, if the data type to be evaluated includes continuous data, and the validator module 118a had already been executed, the data analysis engine 115 can decide that validator module 118b also needs to be executed. If additional validator modules 118 need to be executed, the data analysis engine 115 returns to box 606. For example, a second validator module can be selected from the plurality of validator modules associated with the validator 106 based at least in part on a data type of the data in the dataset being analyzed. The second validator module can be executed to determine a second validation result associated with the data in the dataset being analyzed. Otherwise, the data analysis engine 115 proceeds to box 618.

At box 618, the data analysis engine 115 aggregates the validator results 121 associated with each of the validator modules 118 to generate the aggregate results 124. The aggregated validator results 124 correspond to an aggregation of the validator results 121 for multiple validator modules 118 that were executed for a given validator 106. For example, if a first validator module and a second validator module 118 are executed, the data analysis engine 115 can generate an aggregated validator results 124 based at least in part on a first validator result 121 associated with the first validator module 118 and a second validator result 121 associated with the second validator module 118. In this example, the aggregated validator results 124 can provide a more precise summary of the data results and highlight the areas in the data that may contain issues that need to be addressed. In some examples, the validator results 121 of the different validator modules 118 can be converted into “anomaly ranks” over each sample in the dataset 109. Then, the data analysis engine 115 can generate the aggregated results 124 by aggregating those ranks. For example, the data analysis engine can 115 generate by (a) averaging them and (b) using Borda count ranking. However, it should be noted that the generation of aggregated results 124 is not limited to averaging and using Borda count ranking as any type of rank aggregation method(s) can be used.

At box 621, the data analysis engine 115 generates a validator results report 212 that includes the aggregate validator results 124 and transmits the validator results report 212 to a client device 206 to be rendered on a display 218 of the client device 206. In some examples, the data analysis engine 115 transmits the validator results report 212 to a client device 206 which can render the validator results report 212 on a display 218 of the client device 206. For example, the data analysis engine 115 can generate a user interface 224 including the validator results report 212 or user interface code for generating the user interface 224 including the validator results report 212 and transmit the user interface 142 or user interface code to a client device 206. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart shows the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowchart shows a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowchart can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

In addition to the foregoing, the various embodiments of the present disclosure include, but are not limited to, the embodiments set forth in the following clauses.

Clause 1. A system for facilitating customizable and modular data analysis, the system comprising: a computing device comprising a processor and a memory; and machine-readable instructions stored in the memory that, when executed by the processor, cause the computing device to at least: receive a dataset and a validation schema from a client device; select a validator to analyze data in the dataset based at least in part on the validation schema; select a validator module associated with the validator based at least in part on a data type of the data in the dataset being analyzed; execute the validator module to determine a validation result associated with the data in the dataset being analyzed; generate a validator results report including the validation result; and transmit the validator results report to the client device.

Clause 2. The system of clause 1, wherein the validator is one of a plurality of validators and the validation schema defines at least a subset of the plurality of validators to use to analyze the dataset, the validator being included in the subset of the plurality of validators.

Clause 3. The system of clause 1 or clause 2, wherein the validation schema is user-defined in response to a user interaction with a user interface rendered on a client device, the user interaction comprising a selection of a validator component associated with the validator.

Clause 4. The system of clause 3, wherein the validator comprises a plurality of validator modules, individual validator modules of the plurality of validator modules being configured to analyze one or more respective data types of a plurality of different data types, the validator module being one of the plurality of validator modules, and the plurality of validator modules associated with validator being unknown to a user defining the validation schema.

Clause 5. The system of any one of clauses 1 to 4, wherein the validator comprises one of a parametric assumptions validator, a conditional independence validator, a distribution shift validator, an anomaly validator, or an out of distribution (ood) inference validator.

Clause 6. The system of any one of clauses 1 to 5, wherein the data type comprises one of time-series data, continuous data, categorical data, or multidimensional data.

Clause 7. The system of any one of clauses 1 to 6, wherein the validator module is one of a plurality of validator modules associated with the validator, individual validator modules being configured to analyze at least one of a plurality of data types.

Clause 8. The system of any one of clauses 1 to 7, wherein the validator module is a first validator module of a plurality of validator modules associated with the validator and the validation result comprises a first validation result, and wherein, when executed, the machine-readable instructions further cause the computing device to at least: select a second validator module from the plurality of validator modules associated with the validator based at least in part on a data type of the data in the dataset being analyzed; execute the second validator module to determine a second validation result associated with the data in the dataset being analyzed; and generate an aggregated result based at least in part on the first validation result and the second validation result, wherein the validator results report comprises the aggregated result.

Clause 9. The system of any one of clauses 1 to 8, wherein, when executed, the machine-readable instructions further cause the computing device to receive a data object associated with the dataset, the data object defining the dataset and one or more splits of the dataset, the one or more splits comprising at least one of a training dataset, a validation dataset, a testing dataset, or an inference dataset.

Clause 10. The system of any one of clauses 1 to 9, wherein the validator is one of a plurality of validators, and when executed, the machine-readable instructions further cause the computing device to: receive a request to create a new validator module from the client device, the request including an identification of a particular validator of the plurality of validators, one or more data types to be supported by the new validator module, and data call information for the new validator module; create the validator module based at least in part on the request; and store the new validator module in association with the particular validator.

Clause 11. A method for facilitating customizable and modular data analysis, the method comprising: receiving, by at least one computing device, a dataset and a validation schema from a client device; selecting, by the at least one computing device, a validator to analyze data in the dataset based at least in part on validation schema; selecting, by the at least computing device, a validator module associated with the validator based at least in part on a data type of the data in the dataset being analyzed; executing, by the at least one computing device, the validator module to determine a validation result associated with the data in the dataset being analyzed; generating, by the at least one computing device, a validator results report including the validation result; and transmitting, by the at least one computing device, the validator results report to the client device.

Clause 12. The method of clause 11, wherein the validator is one of a plurality of validators and the validation schema defines at least a subset of the plurality of validators to use to analyze the dataset, the validator being included in the subset of the plurality of validators.

Clause 13. The method of clause 11 or clause 12, wherein the validation schema is user-defined in response to a user interaction with a user interface rendered on a client device, the user interaction comprising a selection of a validator component associated with the validator.

Clause 14. The method of clause 13, wherein the validator comprises a plurality of validator modules, individual validator modules of the plurality of validator modules being configured to analyze one or more respective data type of a plurality of different data types, the validator module being one of the plurality of validator modules, and the plurality of validator modules associated with validator being unknown to a user defining the validation schema.

Clause 15. The method of any one of clauses 11 to 14, wherein the validator comprises one of a parametric assumptions validator, a conditional independence validator, a distribution shift validator, an anomaly validator, or an out of distribution (ood) inference validator.

Clause 16. The method of any one of clauses 11 to 15, wherein the date type comprises one of time-series data, continuous data, categorical data, or multidimensional data.

Clause 17. The method of any one of clauses 11 to 16, wherein the validator module is one of a plurality of validator modules associated with the validator, individual validator modules being configured to analyze at least one of a plurality of data types.

Clause 18. The method of any one of clauses 11 to 17, wherein the validator module is a first validator module of a plurality of validator modules associated with the validator and the validation result comprises a first validation result, and further comprising: selecting a second validator module from the plurality of validator modules associated with the validator based at least in part on a data type of the data in the dataset being analyzed; executing the second validator module to determine a second validation result associated with the data in the dataset being analyzed; and generating an aggregated result based at least in part on the first validation result and the second validation result, wherein the validator results report comprises the aggregated result.

Clause 19. The method of any one of clauses 11 to 18, further comprising receiving a data object associated with the dataset, the data object defining the dataset and one or more splits of the dataset, the one or more splits comprising at least one of a training dataset, a validation dataset, a testing dataset, or an inference dataset.

Clause 20. The method of any one of clauses 11 to 19, wherein the validator is one of a plurality of validators, and further comprising: receiving a request to create a new validator module from the client device, the request including an identification of a particular validator of the plurality of validators, one or more data types to be supported by the new validator module, and data call information for the new validator module; creating the validator module based at least in part on the request; and storing the new validator module in association with the particular validator.

Clause 21. A non-transitory, computer-readable medium for facilitating customizable and modular data analysis, the non-transitory, computer-readable medium comprising machine-readable instructions that, when executed by a processor of a computing device, cause the computing device to at least: receive a dataset and a validation schema from a client device; select a validator to analyze data in the dataset based at least in part on validation schema; select a validator module associated with the validator based at least in part on a data type of the data in the dataset being analyzed; execute the validator module to determine a validation result associated with the data in the dataset being analyzed; generate a validator results report including the validation result; and transmit the validator results report to the client device.

Clause 22. The non-transitory, computer-readable medium of clause 21, wherein the validator is one of a plurality of validators and the validation schema defines at least a subset of the plurality of validators to use to analyze the dataset, the validator being included in the subset of the plurality of validators.

Clause 23. The non-transitory, computer-readable medium of clause 21 or clause 22, wherein the validation schema is user-defined in response to a user interaction with a user interface rendered on a client device, the user interaction comprising a selection of a validator component associated with the validator.

Clause 24. The non-transitory, computer-readable medium of clause 23, wherein the validator comprises a plurality of validator modules, individual validator modules of the plurality of validator modules being configured to analyze one or more respective data types of a plurality of different data types, the validator module being one of the plurality of validator modules, and the plurality of validator modules associated with validator being unknown to a user defining the validation schema.

Clause 25. The non-transitory, computer-readable medium of any one of clauses 21 to 24, wherein the validator comprises one of a parametric assumptions validator, a conditional independence validator, a distribution shift validator, an anomaly validator, or an out of distribution (ood) inference validator.

Clause 26. The non-transitory, computer-readable medium of any one of clauses 21 to 15, wherein the date type comprises one of time-series data, continuous data, categorical data, or multidimensional data.

Clause 27. The non-transitory, computer-readable medium of any one of clauses 21 to 26, wherein the validator module is one of a plurality of validator modules associated with the validator, individual validator modules being configured to analyze at least one of a plurality of data types.

Clause 28. The non-transitory, computer-readable medium of any one of clauses 21 to 27, wherein the validator module is a first validator module of a plurality of validator modules associated with the validator and the validation result comprises a first validation result, and wherein, when executed, the machine-readable instructions further cause the computing device to at least: select a second validator module from the plurality of validator modules associated with the validator based at least in part on a data type of the data in the dataset being analyzed; execute the second validator module to determine a second validation result associated with the data in the dataset being analyzed; and generate an aggregated result based at least in part on the first validation result and the second validation result, wherein the validator results report comprises the aggregated result.

Clause 29. The non-transitory, computer-readable medium of any one of clauses 21 to 28, wherein, when executed, the machine-readable instructions further cause the computing device to receive a data object associated with the dataset, the data object defining the dataset and one or more splits of the dataset, the one or more splits comprising at least one of a training dataset, a validation dataset, a testing dataset, or an inference dataset.

Clause 30. The non-transitory, computer-readable medium of any one of clauses 21 to 29, wherein the validator is one of a plurality of validators, and when executed, the machine-readable instructions further cause the computing device to: receive a request to create a new validator module from the client device, the request including an identification of a particular validator of the plurality of validators, one or more data types to be supported by the new validator module, and data call information for the new validator module; create the validator module based at least in part on the request; and store the new validator module in association with the particular validator.

Clause 31. The system of any of clauses 1 to 10, wherein, when executed, the machine-readable instructions further cause the computing device to at least: transform at least a portion of the data in the dataset a different data format based at least in part on one or more transformation functions.

Clause 32. The system of clause 31, wherein, when executed, the machine-readable instructions further cause the computing device to at least: store the transformed data in a data cache.

Clause 33. The system of clause 31 or 32, wherein the one or more transformation functions are included in a transformation library.

Clause 34. The method of any of clauses 11 to 20, further comprising: transforming at least a portion of the data in the dataset a different data format based at least in part on one or more transformation functions.

Clause 35. The method of clause 34, wherein, when executed, the machine-readable instructions further cause the computing device to at least: store the transformed data in a data cache.

Clause 36. The method of clause 34 or 35, wherein the one or more transformation functions are included in a transformation library.

Clause 37. The non-transitory, computer-readable medium of any of clause 22 to 30, wherein, when executed, the machine-readable instructions further cause the computing device to at least: transform at least a portion of the data in the dataset to a different data format based at least in part on one or more transformation functions.

Clause 38. The non-transitory, computer-readable medium of clause 37, wherein, when executed, the machine-readable instructions further cause the computing device to at least: store the transformed data in a data cache.

Clause 39. The non-transitory, computer-readable medium of clauses 37 or 38, wherein the one or more transformation functions are included in a transformation library.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system for facilitating customizable and modular data analysis, the system comprising:
a computing device comprising a processor and a memory; and
machine-readable instructions stored in the memory that, when executed by the processor, cause the computing device to at least:
receive a dataset and a validation schema from a client device;
select a validator to analyze data in the dataset based at least in part on the validation schema;
select a validator module associated with the validator based at least in part on a data type of the data in the dataset being analyzed;
execute the validator module to determine a validation result associated with the data in the dataset being analyzed;
generate a validator results report including the validation result; and
transmit the validator results report to the client device.

2. (canceled)

3. The system of claim 1, wherein the validation schema is user-defined in response to a user interaction with a user interface rendered on a client device, the user interaction comprising a selection of a validator component associated with the validator.

4. The system of claim 3, wherein the validator comprises a plurality of validator modules, individual validator modules of the plurality of validator modules being configured to analyze one or more respective data types of a plurality of different data types, the validator module being one of the plurality of validator modules, and the plurality of validator modules associated with validator being unknown to a user defining the validation schema.

5-7. (canceled)

8. The system of claim 1, wherein the validator module is a first validator module of a plurality of validator modules associated with the validator and the validation result comprises a first validation result, and wherein, when executed, the machine-readable instructions further cause the computing device to at least:
select a second validator module from the plurality of validator modules associated with the validator based at least in part on a data type of the data in the dataset being analyzed;
execute the second validator module to determine a second validation result associated with the data in the dataset being analyzed; and
generate an aggregated result based at least in part on the first validation result and the second validation result, wherein the validator results report comprises the aggregated result.

9. The system of claim 1, wherein, when executed, the machine-readable instructions further cause the computing device to receive a data object associated with the dataset, the data object defining the dataset and one or more splits of the dataset, the one or more splits comprising at least one of a training dataset, a validation dataset, a testing dataset, or an inference dataset.

10. The system of claim 1, wherein the validator is one of a plurality of validators, and when executed, the machine-readable instructions further cause the computing device to:
receive a request to create a new validator module from the client device, the request including an identification of a particular validator of the plurality of validators, one or more data types to be supported by the new validator module, and data call information for the new validator module;
create the validator module based at least in part on the request; and
store the new validator module in association with the particular validator.

11. The system of claim 1, wherein, when executed, the machine-readable instructions further cause the computing device to at least:
transform at least a portion of the data in the dataset a different data format based at least in part on one or more transformation functions stored in a transformation library.

12-13. (canceled)

14. A method for facilitating customizable and modular data analysis, the method comprising:
receiving, by at least one computing device, a dataset and a validation schema from a client device;
selecting, by the at least one computing device, a validator to analyze data in the dataset based at least in part on validation schema;
selecting, by the at least computing device, a validator module associated with the validator based at least in part on a data type of the data in the dataset being analyzed;
executing, by the at least one computing device, the validator module to determine a validation result associated with the data in the dataset being analyzed;
generating, by the at least one computing device, a validator results report including the validation result; and
transmitting, by the at least one computing device, the validator results report to the client device.

15. (canceled)

16. The method of claim 14, wherein the validation schema is user-defined in response to a user interaction with a user interface rendered on a client device, the user interaction comprising a selection of a validator component associated with the validator.

17. The method of claim 16, wherein the validator comprises a plurality of validator modules, individual validator modules of the plurality of validator modules being configured to analyze one or more respective data types of a plurality of different data types, the validator module being one of the plurality of validator modules, and the plurality of validator modules associated with validator being unknown to a user defining the validation schema.

18-20. (canceled)

21. The method of claim 14, wherein the validator module is a first validator module of a plurality of validator modules associated with the validator and the validation result comprises a first validation result, and further comprising:
selecting a second validator module from the plurality of validator modules associated with the validator based at least in part on a data type of the data in the dataset being analyzed;
executing the second validator module to determine a second validation result associated with the data in the dataset being analyzed; and
generating an aggregated result based at least in part on the first validation result and the second validation result, wherein the validator results report comprises the aggregated result.

22. The method of claim 14, further comprising receiving a data object associated with the dataset, the data object defining the dataset and one or more splits of the dataset, the one or more splits comprising at least one of a training dataset, a validation dataset, a testing dataset, or an inference dataset.

23. The method of claim 14, wherein the validator is one of a plurality of validators, and further comprising:
receiving a request to create a new validator module from the client device, the request including an identification of a particular validator of the plurality of validators, one or more data types to be supported by the new validator module, and data call information for the new validator module;
creating the validator module based at least in part on the request; and
storing the new validator module in association with the particular validator.

24. The method of claim 14, further comprising:
transforming at least a portion of the data in the dataset a different data format based at least in part on one or more transformation functions stored in a transformation library.

25-26. (canceled)

27. A non-transitory, computer-readable medium for facilitating customizable and modular data analysis, the non-transitory, computer-readable medium comprising machine-readable instructions that, when executed by a processor of a computing device, cause the computing device to at least:
receive a dataset and a validation schema from a client device;
select a validator to analyze data in the dataset based at least in part on validation schema;
select a validator module associated with the validator based at least in part on a data type of the data in the dataset being analyzed;
execute the validator module to determine a validation result associated with the data in the dataset being analyzed;
generate a validator results report including the validation result; and
transmit the validator results report to the client device.

28. (canceled)

29. The non-transitory, computer-readable medium of claim 27, wherein the validation schema is user-defined in response to a user interaction with a user interface rendered on a client device, the user interaction comprising a selection of a validator component associated with the validator, and
wherein the validator comprises a plurality of validator modules, individual validator modules of the plurality of validator modules being configured to analyze one or more respective data types of a plurality of different data types, the validator module being one of the plurality of validator modules, and the plurality of validator modules associated with validator being unknown to a user defining the validation schema.

30. (canceled)

31-33. (canceled)

34. The non-transitory, computer-readable medium of claim 27, wherein the validator module is a first validator module of a plurality of validator modules associated with the validator and the validation result comprises a first validation result, and wherein, when executed, the machine-readable instructions further cause the computing device to at least:
select a second validator module from the plurality of validator modules associated with the validator based at least in part on a data type of the data in the dataset being analyzed;
execute the second validator module to determine a second validation result associated with the data in the dataset being analyzed; and
generate an aggregated result based at least in part on the first validation result and the second validation result, wherein the validator results report comprises the aggregated result.

35. The non-transitory, computer-readable medium of claim 27, wherein, when executed, the machine-readable instructions further cause the computing device to receive a data object associated with the dataset, the data object defining the dataset and one or more splits of the dataset, the one or more splits comprising at least one of a training dataset, a validation dataset, a testing dataset, or an inference dataset.

36. The non-transitory, computer-readable medium of claim 27, wherein the validator is one of a plurality of validators, and when executed, the machine-readable instructions further cause the computing device to:
receive a request to create a new validator module from the client device, the request including an identification of a particular validator of the plurality of validators, one or more data types to be supported by the new validator module, and data call information for the new validator module;
create the validator module based at least in part on the request; and
store the new validator module in association with the particular validator.

37. The non-transitory, computer-readable medium of claim 27, wherein, when executed, the machine-readable instructions further cause the computing device to at least:
transform at least a portion of the data in the dataset to a different data format based at least in part on one or more transformation functions stored in a transformation library.

38-39. (canceled)
